(19) United States
(12) Patent Application Publication
(10) Pub. No.: US 2013/0093962 A1
(43) Pub. Date: Apr. 18, 2013

(54) SYSTEMS AND METHODS FOR PAIRING A REMOTE CONTROL TO VIDEO OR AUDIO COMPONENTS USING ULTRASOUND SIGNALS

(71) Applicants: Christopher Bruhn, Aurora, CO (US); Adam Schafer, Lone Tree, CO (US)

(72) Inventors: Christopher Bruhn, Aurora, CO (US); Adam Schafer, Lone Tree, CO (US)

(73) Assignee: ECHOSTAR TECHNOLOGIES L.L.C., Englewood, CO (US)

(21) Appl. No.: 13/274,089

(22) Filed: Oct. 14, 2011

(51) Int. Cl. H04N 5/44

(52) U.S. Cl. 348/734; 348/E05.096

(57) ABSTRACT

Methods and systems for pairing remote controls to video or audio components are provided. The remote control, for example, may include, but is not limited to, an ultrasound receiver and a controller coupled to the ultrasound receiver. The controller may be configured to receive an ultrasound signal from the ultrasound receiver, extract pairing data from the ultrasound signal, and configure the remote control based upon the pairing data.

### TECHNICAL FIELD

The following relates to systems and methods for pairing remote controls to video or audio components, and more particularly, to using ultrasound signals to pair remote controls to video or audio components.

### BACKGROUND

Remote controls which can control multiple devices in one or more rooms of a household or business are becoming more popular. Traditional remote controls use infrared signals to transmit signals to televisions or set top boxes. An infrared remote control, however, typically requires a line of sight to communicate with a device. IR remote controls therefore tend to fail when communicating with devices hidden behind objects such as walls, glass or wooden panels, or the like.

More recently, remote controls have been designed to use radio frequency (RF) signals to transmit signals. RF remote controls do not generally require a line of site with a target device since RF signals can easily pass through walls, glass and cabinets. Accordingly, RF remote controls can often allow users to hide set top boxes and other components behind cabinets. Since the RF signals pass through walls, however, the RF remote control may unintentionally activate devices in other rooms if not properly configured. If a single remote control is to be used to control multiple devices (e.g., video components associated with televisions located in different rooms), it can present a challenge for the remote to know which device the user intends to control at any particular time.

Accordingly, there is a need for a remote control pairing system for RF remote controls that allows the RF remote to control a device located in the same room as the remote control, while still allowing the remote control to control devices located in other rooms when appropriate.

### SUMMARY

In accordance with one embodiment, a remote control is provided. The remote control may include, but is not limited to, an ultrasound receiver and a controller coupled to the ultrasound receiver. The controller may be configured to receive an ultrasound signal from the ultrasound receiver, extract pairing data from the ultrasound signal, and configure the remote control based upon the pairing data.

In accordance with another embodiment, a method of pairing a remote control having a processor and an ultrasound receiver to a video or audio component is provided. The method may include, but is not limited to, sweeping, by the ultrasound receiver, for one or more ultrasound signals, selecting, by the processer, the ultrasound signal with the highest signal strength, extracting, by the processer, paring data from the selected ultrasound signal, and pairing, by a processer, the remote control to the video or audio component using the pairing data.

In accordance with yet another embodiment, an entertainment device is provided. The video or audio component may include, but is not limited to, an ultrasound transmitter and a controller electrically coupled to the ultrasound transmitter. The controller can be configured to cause the ultrasound transmitter to output an ultrasound signal including pairing data for the video or audio component.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### DESCRIPTION OF THE DRAWING FIGURES

Exemplary embodiments will hereinafter be described in conjunction with the following drawing figures, wherein like numerals denote like elements.

FIG. 1 illustrates an exemplary ultrasound pairing system, in accordance with an embodiment;

FIG. 2 is a block diagram of an exemplary video or audio component and remote control, in accordance with an embodiment;

FIG. 3 is a flow diagram illustrating an exemplary method for outputting pairing information using ultrasound signals from a video or audio component; and

FIG. 4 is a flow diagram illustrating an exemplary method for pairing a remote control to a video or audio component.

### DETAILED DESCRIPTION

According to various exemplary embodiments, systems and methods for pairing a remote control to a set top box or other video or audio components using ultrasound signals are provided.

In various embodiments, a remote control is configured to process ultrasonic signals received from set top boxes or other video or audio components that are located in proximity to the remote. Since ultrasound does not typically travel through walls or other objects, the presence of an ultrasonic signal can be used to detect the relative proximity of another object. As the user carries a remote control around a home or other environment, then, the remote can receive ultrasonic signals from televisions, set top boxes, media players or other components that are in relative spatial proximity to the remote. Further, the ultrasonic signal could include pairing information that is used to allow the remote control to communicate with the device or component transmitting the ultrasonic signal.

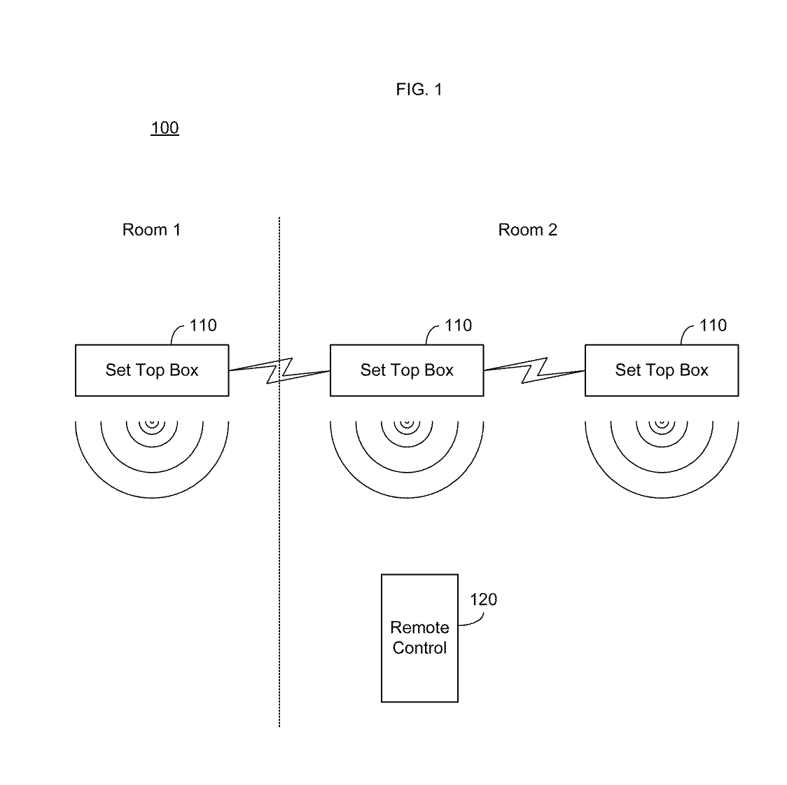

FIG. 1 illustrates an exemplary ultrasound pairing system 100, in accordance with one exemplary embodiment. The ultrasound pairing system 100 shown in FIG. 1 includes at least one video or audio component 110 and at least one remote 120. In one embodiment, for example, the video or audio component 110 may be an entertainment device, such as a set top box. Set top boxes are typically used to convert signals from a cable or satellite provider into signals that can be used by a television to produce video and sound. The video or audio component 110 could also be other entertainment devices, such as a DVD player, a CD player, an audio receiver, a video game system, a television, or the like. The video or audio component 110 uses ultrasound signals to transmit pairing information to the remote control 120 as discussed in further detail below. The number of video or audio components 110 and distribution of video or audio components 110 between rooms can vary widely. In the embodiment illustrated in FIG. 1, there are two rooms, where a first room includes a single video or audio component 110 and a second room includes two video or audio components 110. The ultrasound pairing system 100 allows the remote control 120 to communicate with the video or audio component that the remote control 120 is closest to and in the same room as, while disabling communication with other video or audio components.

The remote control 120 in this example utilizes a radio frequency (RF) signals, such as the radio frequency for consumer electronics (RF4CE) protocol or the like. Remote control 120 therefore uses an RF (radio frequency) transmitter or transceiver to communicate with video or audio components 110. The RF signals utilized by RF4CE remote controls typically pass through walls, cabinet doors and glass, allowing users to hide video or audio components 110 away while still being able to control the video or audio component 110.

In various embodiments, the remote control 120 can be paired with any single video or audio component 110 or multiple video or audio components 110 that are in physical proximity to the remote so that the remote is able to control any of the devices. Since RF signals pass through walls, devices in other rooms which a user may not wish to control could be unintentionally activated if pairing were performed solely using RF signals. Accordingly, the remote control 120 utilizes ultrasound signals to pair with the closest video or audio component 110 that is in the same room as the remote control, as discussed in further detail below.

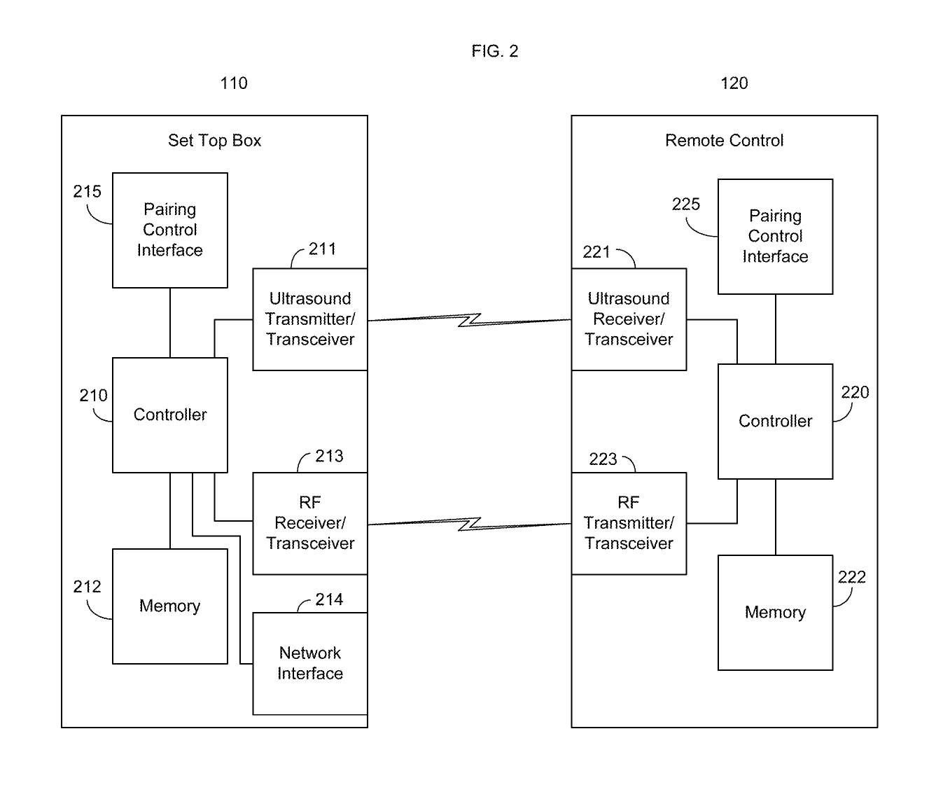

FIG. 2 is a block diagram of an exemplary video or audio component 110 and remote control 120, in accordance with an embodiment. The video or audio component 110 includes a controller 210 coupled to an ultrasound transmitter 211. Various controllers 210 that may be used include, but are not limited to, central processing units (CPUs), graphical processing units (GPUs), application specific integrated circuits (ASICs), field programmable gate arrays (FPGAs), microcontrollers, or any other type of processor or logic device. The video or audio component 110 further includes a memory 212 coupled to the controller. The memory may be any type of memory and can be used to store pairing information for the video or audio component 110. The video or audio component 110 also includes an RF receiver or transceiver 213 coupled to the controller 210 to communicate with the remote control 120 using a RF communication profile, such as RF4CE.

The ultrasound transmitter 211 may be capable of transmitting any ultrasound signal using any type of modulation. In one embodiment, for example, the ultrasound transmitter 211 may output a digital signal using bursts of ultrasound signal. For example, the ultrasound transmitter can transmit an active ultrasound signal for a predetermined duration to output a one-bit and output no signal for the predetermined duration to output a zero-bit. In other embodiments, for example, the ultrasound transmitter 211 could use amplitude modulation (using double-sideband modulation (DSB), single-sideband modulation, vestigial sideband modulation (VSB, or VSB-AM), or quadrature amplitude modulation (QAM)), frequency modulation, phase modulation, or any other type of modulation. In another embodiment, for example, the ultrasound transmitter 211 may be an ultrasonic transceiver, capable of both transmitting and receiving ultrasound signals, as discussed in further detail below. In yet another embodiment, the video or audio component 110 may include an ultrasound receiver. In this embodiment, for example, the remote control 120 may transmit pairing information to the video or audio component 110.

In one embodiment, for example, the strength of the signal output by the video or audio component 110 may be preset and stored in the memory 212. The signal strength may be preset to a strength such that the output ultrasound signal tends not to pass through walls. In another embodiment, for example, the signal strength may be adjustable through the pairing control interface 215, as discussed in further detail below.

In one embodiment, for example, the video or audio component 110 may also include a network interface 214 coupled to the controller 210. The network interface 214 may be used to communicate with other video or audio components 110 as illustrated in FIG. 1. The network interface 214 can utilize a wired communications system, a wireless communications system, or a combination thereof. The controller 210 can utilize the network interface 214 to communicate with other video or audio components 110 to coordinate which ultrasound frequency and/or scheme each video or audio component 110 will use to pair with the remote control 120. In one embodiment, for example, one of the video or audio components 110 can be assigned as the master video or audio component. In this embodiment, the master video or audio component can assign a frequency or another attribute, such as a modulation scheme, to each video or audio component 110. The frequency or other attribute for each video or audio component 110 can be stored in the memory 212 in each video or audio component 110. In another embodiment, the frequency or attribute can be assigned by a user and stored in the memory 212. In yet another embodiment, for example, the frequency or attribute can be assigned by the controller 210 based upon an identifying attribute of the video or audio component 110. For example, the controller 210 can determine a frequency or other attribute based upon an identifying attribute of the video or audio component, for example, by performing a hash function on a media access control (MAC) address or a hardware address of the video or audio component 110.

In one embodiment, for example, the video or audio component 110 also includes a pairing control interface 215. The pairing control interface 215 is coupled to the controller 210 and may be used to control the initiation of the pairing sequence, as discussed in further detail below. In one embodiment, for example, the pairing control interface 215 may be a button (hard or soft) on the front of the video or audio component 110. In another embodiment, for example, the pairing control interface 215 may allow a user to adjust the signal strength output by the ultrasound transmitter 211. The room that the video or audio component 110 is in could be of any size and layout and may have furniture therein which could block or obscure the ultrasound signal. Accordingly, a user can adjust a signal strength level to increase or decrease the signal strength to compensate for the size of the room and any furniture therein. Furthermore, the user may wish to adjust the signal strength output by a video or audio component 110 when there are multiple video or audio components 110 in close proximity to each other. For example, a business, such as a restaurant, may have multiple video or audio components in a single room. By adjusting the signal strength output by each video or audio component 110, the user can create a system whereby merely approaching the appropriate video or audio component 110 the remote control 120 can pair with that specific video or audio component 110.

The remote control 120 includes a controller 220. Various controllers 220 that may be used include, but are not limited to, central processing units (CPUs), graphical processing units (GPUs), application specific integrated circuits (ASICs), field programmable gate arrays (FPGAs), microcontrollers, or any other type of processor or logic device. The remote control 120 further includes a memory 222 coupled to the controller 220. The memory 222 may be any type of memory and can be used to store pairing information for a video or audio component 110. The remote control 120 also includes an RF transmitter or transceiver 223 coupled to the controller 220 to communicate with the video or audio component 110 using a RF communication profile, such as RF4CE.

The controller is also coupled to an ultrasound receiver or transceiver 221. The ultrasound receiver or transceiver 221 may be capable of receiving ultrasound signals over a wide frequency range and of any of the modulation schemes discussed above. The ultrasound signal is used to pair the remote control 120 to the video or audio component 110 that transmitted the ultrasound signal, as discussed in further detail below.

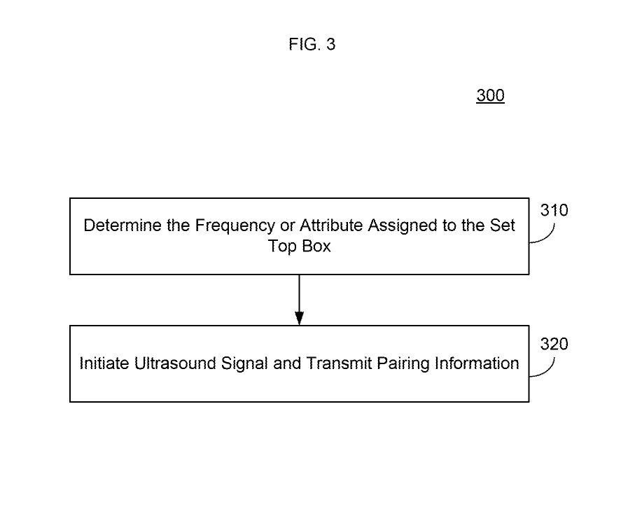

FIG. 3 is a flow diagram illustrating an exemplary method 300 for outputting pairing information using ultrasound signals from a video or audio component 110. The video or audio component 110 first determines the frequency or unique attribute assigned to the video or audio component 110. (Step 310) As discussed above, in one embodiment a video or audio component 110 may receive a frequency or other attribute assignment from a master video or audio component, or another source as desired. In other embodiments, the control attributes of video or audio component 110 are defined by the product manufacturer or distributor, as appropriate.

The controller 210 then initiates an ultrasound transmission from the ultrasound transmitter 211 using the determined frequency or unique attribute. (Step 320). In one embodiment, for example, the controller 210 may be configured to initiate the ultrasound signal whenever power is supplied to the video or audio component 110. Accordingly, whenever a user enters a room with the remote control 120, the remote control 120 can automatically be paired with the video or audio component in that room, as discussed in further detail below. In another embodiment, for example, a user can initiate a pairing sequence by interacting with the pairing control interface 215 on the video or audio component. 110. In yet another embodiment, when the video or audio component includes an ultrasound transceiver 211, the controller 210 may monitor the ultrasound transceiver 211 to determine if the video or audio component 110 has received an ultrasound pairing request from a remote control 120. As discussed above, the remote control 120 may include an ultrasound transceiver 221 that can transmit a signal requesting pairing information from a video or audio component 110. As discussed above, the user can interact with a pairing control interface 225 of the remote control 120 to request initiation of the pairing sequence.

The ultrasound signal output from the ultrasound transmitter 211 contains pairing information that the remote control 120 can use to pair with the video or audio component 110. In one embodiment, for example, the ultrasound signal may contain a key, such as a MAC address, of the video or audio component. In another embodiment, for example, the remote 120 may use a lookup table stored in memory 222 to identify the video or audio component 110 that is associated with the frequency and/or attribute modulation type in order to pair with the associated device. The remote control 120 can use the key to pair with the video or audio component. In one embodiment, for example, the controller 210 may encode the pairing information prior to transmission. In this embodiment, the controller 220 of the remote control 120 would have to decode the pairing information prior to pairing the devices.

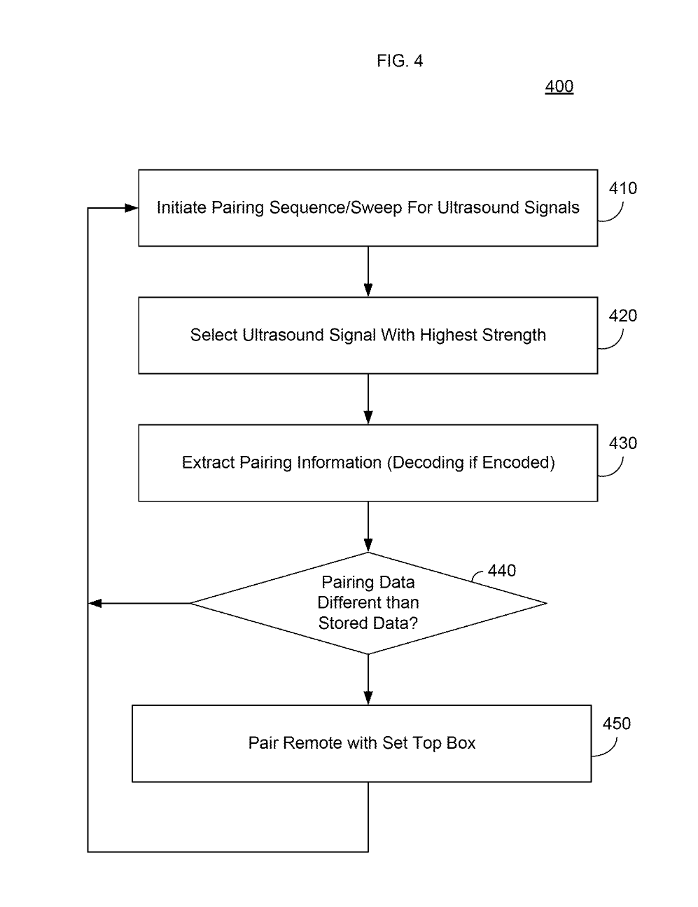

FIG. 4 is a flow diagram illustrating an exemplary method 400 for pairing a remote control 120 to a video or audio component 110. The remote control 120 first initiates the pairing sequence. (Step 410). As discussed above, in one embodiment the pairing sequence can be initiated from the remote control 120 when a user interacts with the pairing control interface 225. Once the ultrasound transceiver 221 has transmitted a pairing request, the controller 220 then monitors the ultrasound transceiver 221 for ultrasound signals. The controller 220, for example, can cause the ultrasound receiver 221 to sweep across a predetermined frequency range for a predetermined period of time to look for ultrasound signals. In another embodiment, for example, the controller 220 of the remote control 120 may constantly monitor the ultrasound receiver 221 to determine if any ultrasound signals are detectable whenever power is supplied to the remote control 120.

Once the controller 220 initiates the signal sweep, the controller 220 determines if any ultrasound signals are present, and, if multiple ultrasound signals are detected, which signal has the highest strength. (Step 420). As discussed above, multiple video or audio components 110 within the same business or household may be able to pair with the remote control 120. Since the remote control 120 utilize ultrasound signals to determine which video or audio components 110 to pair with rather than RF signals, the signal with the highest strength is more likely to be the video or audio component 110 in the same room as the remote control 120.

After the controller 220 has determined the ultrasound signal with the highest signal strength, the controller 220 extracts pairing information from the signal. (Step 430). In other embodiments, for example, the controller extracts pairing information from all of the detected ultrasound signals to pair with all of the video or audio components 110 in spatial proximity to the remote control 120. As discussed above, each video or audio component 110 may use any modulation scheme or burst scheme to transfer data. Further, the data transmitted by the video or audio component 110 may be encoded. In one embodiment, for example, the video or audio component 110 may utilize an advanced encryption standard (AES) encoding system to encode the data. In this embodiment, a user may enter a code into the remote control 120 so that the controller 220 can decrypt and extract the pairing information.

Once the controller 220 has extracted the pairing information, the controller 220 compares the extracted pairing data with any pairing data stored in the memory 222. (Step 440). If the extracted pairing data is the same as the stored pairing data, the controller returns to step 410 to either continue monitoring for ultrasound signals or to wait for another ultrasound pairing request to be initiated.

If the extracted pairing data is different than the data stored in the memory 222, the controller than pairs the remote control 120 to the video or audio component 110 using the extracted pairing data. (Step 450). The controller then returns to step 410 to either continue monitoring for ultrasound signals or to wait for another ultrasound pairing request to be initiated.

In one embodiment, for example, the memory 222 may be configured to store pairing data for only a single video or audio component. Accordingly, in this embodiment, the controller 220 overwrites or replaces the pairing data stored in memory 222 with the new extracted pairing data. In other embodiments, the memory 222 may be capable of pairing data with multiple video or audio components 110. In these embodiments, when the controller 222 detects a new pairing, the controller may be configured to disable any older pairings stored in the memory 222. In another embodiment, a master video or audio component may be configured to transmit the pairing information for all of the video or audio components 110 in spatial proximity to the master component.

Generally speaking, the various functions and features of methods 300 and 400 may be carried out with any sort of hardware, software and/or firmware logic that is stored and/or executed on any platform. Some or all of methods 300 and 400 may be carried out, for example, by the controllers 210 and/or 220 illustrated in FIG. 2. Further, various functions shown in FIGS. 3 & 4 may be implemented using software or firmware logic. The particular hardware, software and/or firmware logic that implements any of the various functions shown in FIGS. 3 & 4, however, may vary from context to context, implementation to implementation, and embodiment to embodiment in accordance with the various features, structures and environments set forth herein. The particular means used to implement each of the various functions shown in FIGS. 3 & 4, then, could be any sort of processing structures that are capable of executing software and/or firmware logic in any format, and/or any sort of application-specific or general purpose hardware, including any sort of discrete and/or integrated circuitry.

The term “exemplary” is used herein to represent one example, instance or illustration that may have any number of alternates. Any implementation described herein as “exemplary” should not necessarily be construed as preferred or advantageous over other implementations.

Although several exemplary embodiments have been presented in the foregoing description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. A remote control, comprising:
an ultrasound receiver; and
a controller coupled to the ultrasound receiver, the controller configured to:
receive an ultrasound signal from the ultrasound receiver;
extract pairing data from the ultrasound signal; and
configure the remote control based upon the pairing data.

2. The remote control of claim 1, wherein when multiple ultrasound signals are detected by the ultrasound receiver, the controller is further configured to:
select one of the multiple ultrasound signals with the highest signal strength;
extract the pairing data from the selected ultrasound signal; and
configure the remote control based upon the pairing data extracted from the selected ultrasound signal.

3. The remote control of claim 1, further comprising:
a pairing control interface coupled to the controller; and
an ultrasound transmitter coupled to the controller,
wherein the controller is further configured to cause the ultrasound transmitter to output an ultrasound pairing request signal in response to an input to the pairing control interface.

4. The remote control of claim 3, wherein the controller, after causing the ultrasound transmitter to output the ultrasound pairing request signal is further configured to cause the ultrasound receiver to sweep for ultrasound signals for a predetermined period of time.

5. The remote control of claim 1, wherein the controller is further configured to decode the pairing information from encoded pairing information contained in the ultrasound signal.

6. The remote control of claim 2, further comprising:
a memory coupled to the controller,
wherein the controller is further configured to:
compare the extracted pairing data with pairing data stored in the memory, and
replace, if the extracted pairing data is different than the pairing data stored in the memory, the pairing data stored in the memory with the extracted pairing data, and
configure the remote control based upon the pairing data stored in the memory.

7. A method of pairing a remote control having a processor and an ultrasound receiver to a video or audio component comprising
monitoring, by the ultrasound receiver, for one or more ultrasound signals;
selecting, by the processer, the ultrasound signal with the highest signal strength from the one or more ultrasound signals;
extracting, by the processer, paring data from the selected ultrasound signal; and
pairing, by a processer, the remote control to the video or audio component using the pairing data.

8. The method of claim 7, wherein when the pairing data is encoded, the extracting further comprises decoding the pairing data using a key stored in a memory.

9. The method of claim 7, further comprising:
transmitting an ultrasound signal requesting pairing information from the video or audio component; and
initiating, by the controller, the sweeping after the ultrasound signal requesting pairing information has been transmitted.

10. The method of claim 7, further comprising initiating the sweeping when power is supplied to the remote control.

11. The method of claim 7, further comprising storing the pairing data in a memory.

12. The method of claim 11, further comprising:
comparing the extracted pairing data with pairing data stored in the memory,
replacing, if the extracted pairing data is different than the pairing data stored in the memory, the pairing data stored in the memory with the extracted pairing data, and
configuring the remote control based upon the pairing data stored in the memory.

13. The method of claim 7, further comprising:
transmitting, by an ultrasound transmitter coupled to the video or audio component, an ultrasound signal including pairing data.

14. The method of claim 13, wherein the pairing data is transmitted using bursts of ultrasound.

15. The method of claim 13, wherein the transmitting is continuous whenever power is supplied to the video or audio component.

16. The method of claim 13, wherein the transmitting occurs for a predetermined period of time in response to a pairing request.

17. The method of claim 13, wherein the video or audio component encodes the transmitted pairing data.

18. An entertainment device, comprising:
an ultrasound transmitter; and
a controller electrically coupled to the ultrasound transmitter, wherein the controller is configured to cause the ultrasound transmitter to output an ultrasound signal including pairing data associated with the entertainment device.

19. The entertainment device of claim 18, further comprising a network interface coupled to the controller, wherein the controller is further configured to communicate with other entertainment devices using the network interface to coordinate which frequency of ultrasound signal each video or audio component will transmit.

20. The entertainment device of claim 18 further comprising:
an ultrasound receiver coupled to the controller,
wherein the controller is further configured to cause the ultrasound transmitter to output the ultrasound signal in response to receiving a pairing request through the ultrasound receiver.
